(19) United States
(12) Patent Application Publication
(10) Pub. No.: US 2026/0185494 A1
(43) Pub. Date: Jul. 2, 2026

(54) ACTIVE DECELERATION CONTROL OF ENGINE BRAKING OPERATION OF A VEHICLE

(71) Applicant: Robert Bosch GmbH, Stuttgart (DE)

(72) Inventors: Bijith T G Pillai, Farmington Hills, MI (US); John Wathen, Farmington Hills, MI (US); Rajit Jayachandran, Farmington Hills, MI (US)

(21) Appl. No.: 19/005,669

(22) Filed: Dec. 30, 2024

(51) Int. Cl. F02D 35/00; B60T 1/12

(52) U.S. Cl. CPC F02D 35/0007; B60T 1/12; F02D 2200/1002; F02D 2200/60

(57) ABSTRACT

Systems and methods directed to active control of an engine braking operation. One aspect is directed to an engine braking control system for a vehicle. The system includes an electronic processor configured to receive a deceleration request, determine a base engine braking level based on a vehicle speed and a vehicle gear, and adjust the base engine braking level according to a brake pressure of the vehicle. The electronic processor is further configured to generate, based on the adjusted base engine braking level and the deceleration request, a target deceleration profile, determine, based on the target deceleration profile, an engine torque demand, and control an engine braking operation of the vehicle by adjusting a torque of an engine of the vehicle according to the engine torque demand, wherein the engine torque demand is updated during the engine braking operation.

### FIELD

This application relates generally to the field of engine acceleration/deceleration and braking control.

### BACKGROUND

Engine braking is a method of decelerating a vehicle using pumping losses and/or friction within the engine to reduce the speed of the vehicle. Engine braking systems may be employed to enhance the braking effect of conventional friction brakes acting on the wheels of the vehicle or, in some circumstances, may be implemented independently of the normal wheel braking system, for instance to control a speed of a vehicle when the vehicle is travelling downhill.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate aspects, examples, aspects, and features of concepts that include the claimed subject matter and explain various principles and advantages of those aspects, examples, aspects, and features.

FIG. 1 is a schematic illustration of a vehicle including an engine braking control system, according to some aspects.

FIG. 2 is a flowchart of a method of controlling an engine braking operation of a vehicle implemented by the system of FIG. 1 in accordance with various examples.

FIG. 3 is a graph illustrating a vehicle acceleration and corresponding vehicle speed during the engine braking operation performed by the engine braking control system.

FIG. 4 is a block diagram illustrating the engine braking control function 400 performed by the engine braking control system of FIG. 1 in accordance with some aspects.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of examples, aspects, and features illustrated.

In some instances, the apparatus and method components have been represented where appropriate by conventional symbols in the drawings, showing only those specific details that are pertinent to understanding the of various aspects, examples, aspects, and features so as not to obscure the disclosure with details that will be readily apparent to those of ordinary skill in the art having the benefit of the description herein.

### DETAILED DESCRIPTION

Traditional engine braking systems typically involve directly controlling a throttle (and thus, the torque) of the engine. However, such systems may not actively control the engine torque throughout the deceleration process of the vehicle. It may be advantageous to monitor and actively adjust the engine torque throughout the engine braking control to maintain a consistent deceleration amount across various road conditions. Active control may improve drivability and safety of the vehicle. Stable, consistent engine braking control may be particularly advantageous for straddle-type vehicles (for example, motorcycles) and off-road powersport vehicles (for example, all-terrain vehicles, utility vehicles, scooters, and the like).

Accordingly, the systems and methods described herein relate to active engine braking control for straddle-type vehicles and powersport vehicles.

In some aspects, the techniques described herein relate to active control of an engine braking operation of a vehicle. Some aspects include an engine braking control system for a vehicle. The system includes an electronic processor configured to receive a deceleration request, determine a base engine braking level based on a vehicle speed and a vehicle gear, and adjust the base engine braking level according to a brake pressure of the vehicle. The electronic processor is further configured to generate, based on the adjusted base engine braking level and the deceleration request, a target deceleration profile, determine, based on the target deceleration profile, an engine torque demand, and control an engine braking operation of the vehicle by adjusting a torque of an engine of the vehicle according to the engine torque demand, wherein the engine torque demand is updated during the engine braking operation.

Some aspects include an electronic control unit for controlling engine braking of a vehicle. The unit includes an electronic processor configured to receive a deceleration request, determine a base engine braking level based on a vehicle speed and a vehicle gear, and adjust the base engine braking level according to a brake pressure of the vehicle. The processor is further configured to generate, based on the adjusted base engine braking level and the deceleration request, a target deceleration profile, determine, based on the target deceleration profile, an engine torque demand, and control an engine braking operation of the vehicle by adjusting a torque of an engine of the vehicle according to the engine torque demand, wherein the engine torque demand is updated during the engine braking operation.

Some aspects include a method of controlling an engine braking operation of a vehicle. The method includes receiving a deceleration request, determining a base engine braking level based on a vehicle speed and a vehicle gear, and adjusting the base engine braking level according to a brake pressure of the vehicle. The method further includes generating, based on the adjusted base engine braking level and the deceleration request, a target deceleration profile, determining, based on the target deceleration profile, an engine torque demand, and controlling the engine braking operation of the vehicle by adjusting a torque of an engine of the vehicle according to the engine torque demand, wherein the engine torque demand is updated during the engine braking operation.

Before any aspects, features, or instances are explained in detail, it is to be understood that the aspects, features, or instances are not limited in their application to the details of construction and the arrangement of components set forth in the following description or illustrated in the following drawings. Other instances are possible and are capable of being practiced or of being carried out in various ways.

It should also be noted that a plurality of hardware and software-based devices, as well as a plurality of different structural components may be utilized in various implementations. Aspects, features, and instances may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one instance, the electronic based aspects of the invention may be implemented in software (for example, stored on non-transitory computer-readable medium) executable by one or more processors. As a consequence, it should be noted that a plurality of hardware and software-based devices, as well as a plurality of different structural components may be utilized to implement the invention. For example, “control units” and “controllers” described in the specification can include one or more electronic processors, one or more memories including a non-transitory computer-readable medium, one or more input/output interfaces, and various connections (for example, a system bus) connecting the components.

Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

It should also be understood that although certain drawings illustrate hardware and software located within particular devices, these depictions are for illustrative purposes only. In some embodiments, the illustrated components may be combined or divided into separate software, firmware, and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable connections or links.

Thus, in the claims, if an apparatus or system is claimed, for example, as including an electronic processor or other element configured in a certain manner, for example, to make multiple determinations, the claim or claim element should be interpreted as meaning one or more electronic processors (or other element) where any one of the one or more electronic processors (or other element) is configured as claimed, for example, to make some or all of the multiple determinations collectively. To reiterate, those electronic processors and processing may be distributed.

Also, it is to be understood that the phraseology and terminology used herein is for the purpose of description and should not be regarded as limiting. The terms “mounted,” “connected” and “coupled” are used broadly and encompass both direct and indirect mounting, connecting, and coupling. Further, “connected” and “coupled” are not restricted to physical or mechanical connections or couplings, and can include electrical connections or couplings, whether direct or indirect. Also, electronic communications and notifications may be performed using any known means including wired connections, wireless connections, etc.

For ease of description, some or all of the example systems presented herein are illustrated with a single exemplar of each of its component parts. Some examples may not describe or illustrate all components of the systems. Other instances may include more or fewer of each of the illustrated components, may combine some components, or may include additional or alternative components.

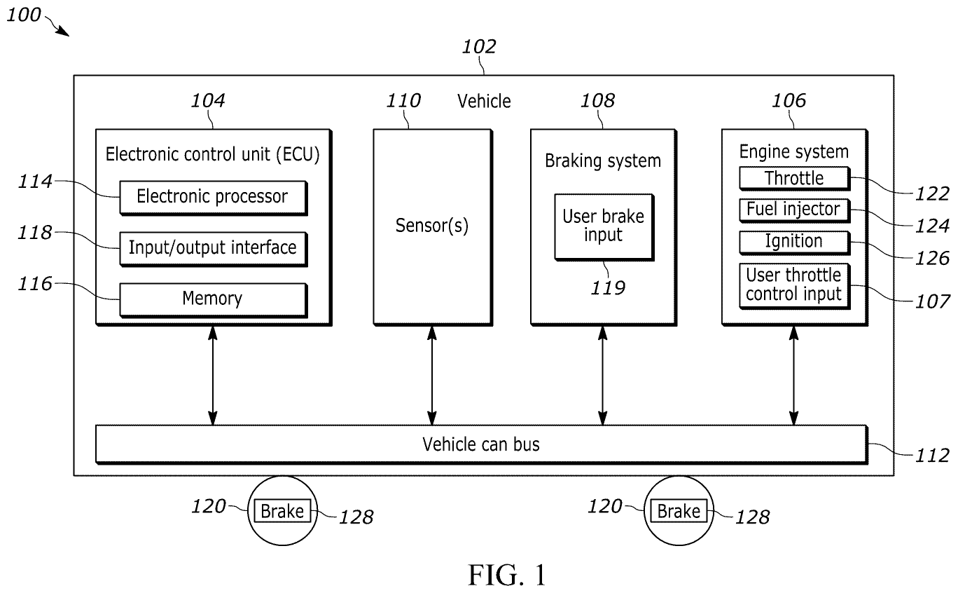

FIG. 1 illustrates an engine braking system 100 of a vehicle 102, according to some aspects. In some instances, the vehicle 102 is a straddle-type vehicle (for example, a motorcycle) or a land-driven powersport vehicle (for example, an all-terrain vehicle (ATV), a utility terrain vehicle (UTV), a scooter, and the like). In some instances, the vehicle 102 is an automobile (for example, a car, a truck, and the like). In the example illustrated, the system 100 includes an electronic control unit (ECU) 104, an engine system 106, a braking system 108, and a plurality of sensors 110. The components of the system 100, along with other various modules and components are electrically and communicatively coupled to each other via direct connections, or via, or through, one or more control or data buses (for example, bus 112), which enable communication therebetween. In some instances, the bus 112 is a controller area network (CAN) bus. In some instances, the bus 112 is an automotive Ethernet, a FlexRay™ communications bus, or another suitable bus. In alternative instances, some or all of the components of the vehicle 100 may be communicatively coupled using suitable wireless modalities (for example, Bluetooth™ or near field communication connections).

The ECU 104 includes an electronic processor 114, a memory 116, and an input/output interface 118. In some examples, the electronic processor 114 is implemented as a microprocessor with separate memory, for example the memory 116. In other examples, the electronic processor 114 may be implemented as a microcontroller (with memory 165 on the same chip). In other examples, the electronic processor 114 may be implemented using multiple processors. In addition, the electronic processor 114 may be implemented partially or entirely as, for example, a field-programmable gate array (FPGA), an applications specific integrated circuit (ASIC), and the like and the memory 116 may not be needed or be modified accordingly. In some examples, the memory 116 includes non-transitory, computer-readable memory that stores instructions that are received and executed by the electronic processor 114 to carry out methods described herein. The memory 116 may include, for example, a program storage area and a data storage area. The program storage area and the data storage area may include combinations of different types of memory, for example read-only memory and random-access memory. The input/output interface 118 may include one or more input mechanisms and one or more output mechanisms (for example, general-purpose input/outputs (GPIOs), analog inputs, digital inputs, and others). The input/output interface 118 may include one or more user inputs (for example, a handlebar, a steering wheel, a lever, a switch, etc.) for a user to provide input to the system 100 to control one or more operations of the vehicle 102.

The input/output interface 118 may also include other input and output mechanisms, which for brevity are not described herein and which may be implemented in hardware, software, or a combination of both. For example, in some aspects, the input/output interface 118 includes a transceiver (not shown) communicating data over one or more wireless communications networks (for example, cellular networks, satellite networks, land mobile radio networks, etc.). The transceiver may also provide wireless communications within the vehicle 102 using suitable network modalities (for example, Bluetooth™, near field communication (NFC), Wi-Fi™, and the like). Accordingly, the transceiver may communicatively couple the ECU 114 and other components of the system 100 with networks or electronic devices both inside and outside the vehicle 102 to send and receive data, commands, and other information. Some aspects include multiple transceivers or separate transmitting and receiving components (for example, a transmitter and a receiver) instead of a combined transceiver.

The engine system 106 includes various components for operation and control of an engine (not shown) for driving one or more wheels 120 of the vehicle 102. The engine system 106 includes, among other things, a throttle 122, a fuel injector 124, and an ignition system 126. The ECU 104 controls the torque output of the engine (and, thus, the wheels 120) by controlling operation of the throttle 122, the fuel injector 124, and the ignition system 126. Operation of the engine may be controlled by the ECU 104 according to an operation of a user throttle input 107 (for example, an accelerator pedal or a hand grip throttle control). It should be understood that, although FIG. 1 illustrates a vehicle with only two wheels 120, the vehicle 102, in some aspects, may include more wheels. In such instances, it should be understood that not all of the wheels of the vehicle 102 are necessarily driven by the engine system 106 (i.e. there are, in some cases “non-driven” or “free” wheels).

The braking system 108 of the vehicle 102 is coupled to a respective brake 128 (for example, a brake having hydraulically-actuated brake calipers or brake drums) of one or more of the wheels 140. The braking system 108 may include a mechanical user brake input 119 (for example, a brake pedal) in which, when actuated, pushes a piston inside a master cylinder, which pressurizes the brake fluid. The pressurized brake fluid is then sent through the brake lines to the brake 128, which slows rotation of the wheel 140 via friction (on the brake disc or drum) to slow down or bring the vehicle 102 to a stop. In some aspects, the braking system 108 includes a brake booster (not shown) that amplifies the force applied by the operator on the user brake input 119.

The system 100 includes one or more sensors 110 within the vehicle 102 configured to measure one or more characteristics of one or more components of the vehicle 102 and/or an environment surrounding the vehicle. In some aspects, one or more of the sensors 110 may be integrated into one or more of the systems of the vehicle 102 (for example, the engine system 106 and/or the braking system 108). The sensor(s) 110 may include, for example, one or more of a speed sensor, a rotational position sensor, an inertia movement sensor, a pressure sensor, a voltage sensor, a current sensor, a radar, an image sensor, and the like.

As described in more detail below, the ECU 104 is configured to receive information from the one or more sensors 110 and the systems 106 and 106 (for example, via the CAN bus 112) and actively control an engine braking operation of the vehicle 102 based on the received information. Such information may include, for example, wheel speed, wheel pressure, brake input position, an accelerator input position, a vehicle lean angle, vehicle speed, vehicle gear, brake pressure, road surface data, road gradient data, and the like.

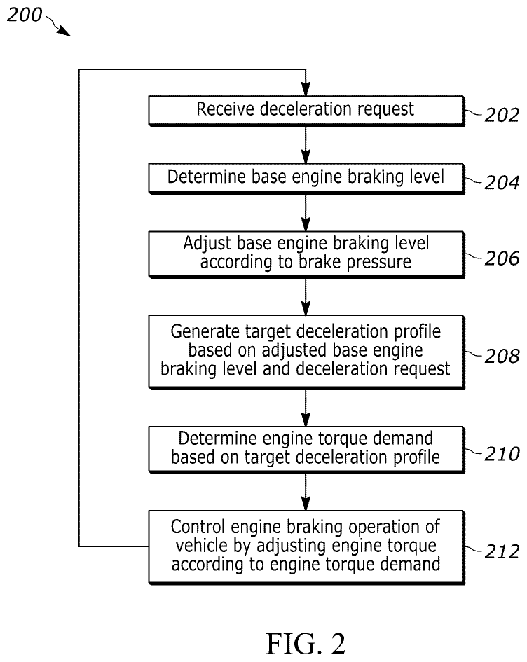

FIG. 2 illustrates an example method 200 of controlling an engine braking operation of a vehicle (for example, the vehicle 102 of FIG. 1) in accordance with some aspects. The method 200 may be modified or performed differently than the specific example provided. As an example, the method 200 is described as being performed by the ECU 104 of the engine braking control system 100 and, in particular, by the electronic processor 114.

At block 202, the electronic processor 114 receives a deceleration request. The deceleration request may be received from a driver of the vehicle 102, for example, via a user input of the input/output interface 118. The user input may be, for example, a throttle control input (for example, actuation of a hand grip throttle control or a release of an accelerator pedal) of the vehicle 102. In some aspects, the deceleration request is automatically generated and provided by a driver assistance system (ADAS) (for example, an advanced rider assistance system (ARAS)), which is not shown, of the vehicle 102.

At block 204, the electronic processor 114 determines an initial base engine braking level of the vehicle 102 based on a current vehicle speed and vehicle gear. The vehicle speed may be determined, for example, via one or more of the sensors 110. The ECU 104 may receive information regarding the current vehicle gear, for example, from the engine system 106 or another system of the vehicle 102. In some aspects, the electronic processor 114 determines the initial base engine braking level of the vehicle 102 based on one or more values from one or more look-up tables stored locally within the vehicle 102 (for example, within the memory 116) or on a separate device (for example, a remote server) selected, for example, based on the vehicle speed and gear. At block 206, the electronic processor 114 adjusts the base engine braking level according to a brake pressure of the braking system 108 of the vehicle 102. The electronic processor 114 increases the base engine braking level in instances where the brake pressure is relatively large and decreases the base engine braking level in instances where the brake pressure is relatively small. In some aspects, the base engine braking level is also adjusted based on a lean angle of the vehicle 102 (for example, in instances where the vehicle 102 is a straddle-type vehicle). For example, the electronic processor 114 may decrease the base engine braking level in instances where the lean angle is relatively large. In some aspects, the electronic processor 114 determines the lean angle of the vehicle 102 based on information from a inertia movement unit (IMU) of the vehicle 102 (not shown). In some aspects, the electronic processor 114 adjusts the initial base engine braking level based on one or more values selected from one or more look-up tables based on one or more of the brake pressure, a type/model of vehicle 102, and the lean angle.

At block 208, the electronic processor 114 generates, based on the adjusted base engine braking level and the deceleration request, a target deceleration profile. The target deceleration profile is a series of projected target deceleration rates over the projected duration of the engine braking operation of the vehicle 102. In some aspects, the target deceleration profile is also be based on a projected gear shift point (for example, in instances where the vehicle 102 includes an automatic transmission system).

In some aspects, the target deceleration profile is determined based on one or more conditions of the surface/road on which the vehicle 102 is being driven. The one or more conditions may include a road gradient (for example, a current or approaching incline/decline). The road gradient may be determined based on information from one or more of the sensors 110 (for example, an image sensor, radar, etc.). In some aspects, the road gradient is determined based on information from a global positioning navigation system (GPS) of the vehicle 102 (not shown) or of another electronic communications device communicatively coupled to the ECU 104 (for example, a smartphone of a user of the vehicle 102). The one or more conditions may additionally or alternatively include a road surface condition (for example, a roughness or smoothness of the road).

It should be understood that the term “road” used herein refers to any surface upon which the vehicle is being driven (both “on-road” and “off-road”).

In some aspects, the target deceleration profile is determined based on a load (weight) of the vehicle 102. The weight of the vehicle 102 is determined, for example, based on information from one or more of the sensors 110. In some aspects, electronic processor 114, in generating the target deceleration profile, is configured to determine a current vehicle driving resistance of the vehicle 102 (for example, via a vehicle driving resistance model). The driving resistance may be determined, for example, based on the load of the vehicle 102, the road gradient, and/or road surface condition. The electronic processor 114 may be configured to determine a predicted acceleration/deceleration (and/or wheel power) of the vehicle 102 based on the load of the vehicle 102, the road gradient, and/or the road surface condition. The electronic processor 114 may then determine and compare a current acceleration/deceleration of the vehicle 102 (and/or wheel power) to the predicted values. The electronic processor 114 then determines a vehicle resistance value based on the comparison and adjusts the target deceleration profile based on the vehicle resistance value.

At block 210, the electronic processor 114 determines, based on the target deceleration profile, an engine torque demand. In one example, the electronic processor 114 converts the target deceleration profile into a series of corresponding torque values. The conversion may be based on, for example, a mass of the vehicle, wheel diameter, the estimated driving resistance. The electronic processor 114 controls an engine braking operation of the vehicle 102 by adjusting a torque of the engine of the vehicle 102 (for example, by controlling one or more of the throttle 122, fuel injector 124, and the ignition 126 of the engine system 106) according to the engine torque demand (block 212).

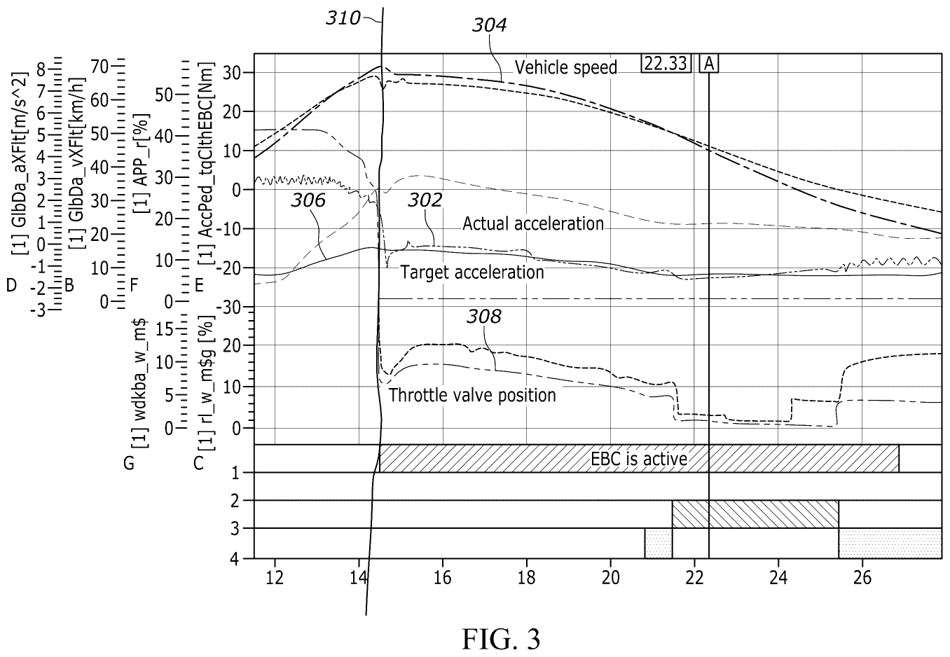

The electronic processor 114 is configured to actively (periodically, repeatedly, or continuously) update the engine torque demand during the engine braking operation (for example, return to block 202 of the method 200), even if the engine of the vehicle is not firing. Thus, the electronic processor 114 controls the engine of the vehicle 102 such that the vehicle 102 decelerates during the engine braking operation at a consistent rate, regardless of road conditions/gradients and changes in vehicle condition. For example, FIG. 3 is a graph 300 illustrating a vehicle acceleration 302 and corresponding vehicle speed 304 during the engine braking operation performed by the engine braking control system 100 according to the method 200 described above. The graph 300 also includes the corresponding target deceleration profile 306 and throttle position 308. As illustrated, throughout the duration of the engine braking operation (beginning at the start 310), the (negative) acceleration of the vehicle 102 remains relatively constant over time. The engine braking operation may be terminated by a driver of the vehicle 102 at any time (for example, by actuating an accelerator input of the vehicle 102).

In some aspects, during the engine braking operation, the electronic processor 114 receives a torque demand from a driver of the vehicle 102 via a user input of the input/output interface 118. The electronic processor 114 may compare the torque demand to the engine torque demand determined at block 210 and adjust the torque of the engine according to the torque demand from the driver instead of the determined engine torque demand in instances where the torque demand is a larger torque value than the determined engine torque demand.

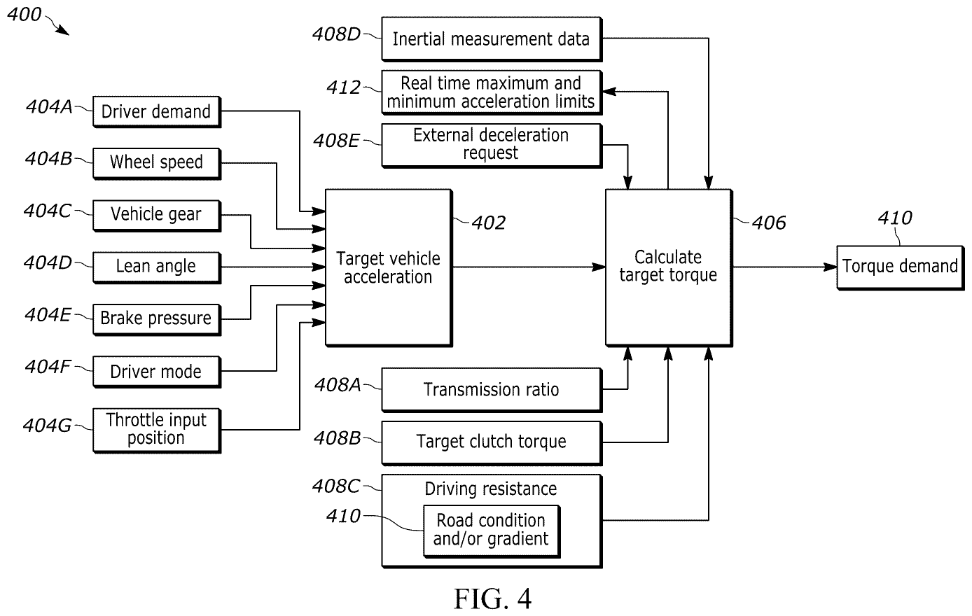

FIG. 4 is a block diagram illustrating the engine braking control function 400 performed by the engine braking control system of FIG. 1 in accordance with some aspects. As illustrated, the target vehicle acceleration/deceleration 402 (for example, the adjusted base engine braking level of block 206 described above with respect to FIG. 2) calculated based on a plurality of factors including one or more of a driver demand 404A, a wheel speed 404B, a vehicle gear 404C, a lean angle of the vehicle 404D, a brake pressure 404E, a drive mode 404F (also known as a vehicle dynamic mode, a preset configuration that alters a handling of the vehicle by altering throttle response, steering feel, traction control, suspension stiffness, etc. depending on the selected mode (for example, a sport mode, an eco mode, a rain mode, a snow mode, a tow/haul mode, and the like)), and a throttle input position 404G. In the illustrated example, within the calculation of the target torque 406, the target deceleration profile (generated at block 208 of FIG. 2) is determined and adjusted based on additional factors including one or more of a transmission ratio 408A, a target clutch torque 408B, and/or a driving resistance 408C (determined, for example, based on a road condition and/or road gradient 410 as described above). Additional factors may also include inertial measurement data 408D of the vehicle 102 (for example, from one or more movement sensors of the sensors 110 and/or from an IMU of the vehicle 102) and/or an external deceleration request 408E (as previously described above). Based on the target torque 406, the electronic processor 114 generates an engine torque demand 410 including the target torque value. In some aspects, the electronic processor 114 generates, in real time, a maximum acceleration limit and a minimum acceleration limit 412. The electronic processor 114 may provide the limits 412 to one or more systems of the vehicle 102. For example, in some aspects, the electronic processor 114 provides the limits 412 to a driver assistance system of the vehicle 102 that performs one or more automatic driving functions (for example, a cruise control function or an obstacle avoidance function). In some aspects, the adjusted base engine braking level is further based on a driver braking setting (for example, a level set by a user of the vehicle 102 (for example, via the input/output interface 118). The driver braking setting allows a user to customize one or more characteristics of the engine braking operation performed by the ECU 104 (for example, a maximum/minimum amount of braking, a duration of the braking, etc.). For example, a user may set a level of the braking force to “Low,” “Medium,” or “High.”

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain implementations and should in no way be construed to limit the claims.

Accordingly, it is to be understood that the above description is intended to be illustrative and not restrictive. Many aspects and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future aspects. In sum, it should be understood that the application is capable of modification and variation.

Various features and advantages of the aspects presented herein are set forth in the following claims.

What is claimed is:

1. An engine braking control system for a vehicle, the system comprising:
an electronic processor configured to:
receive a deceleration request;
determine a base engine braking level based on a vehicle speed and a vehicle gear;
adjust the base engine braking level according to a brake pressure of the vehicle;
generate, based on the adjusted base engine braking level and the deceleration request, a target deceleration profile;
determine, based on the target deceleration profile, an engine torque demand; and
control an engine braking operation of the vehicle by adjusting a torque of an engine of the vehicle according to the engine torque demand,
wherein the engine torque demand is updated during the engine braking operation.

2. The system of claim 1, wherein the deceleration request is received from a driver assistance system.

3. The system of claim 1, wherein the electronic processor is further configured to generate the target deceleration profile based on a projected gear shift point.

4. The system of claim 1, wherein the deceleration request is received from a driver of the vehicle.

5. The system of claim 1, wherein the electronic processor is further configured to
receive, during the engine braking operation, a torque demand from a driver of the vehicle via a user input; and
control the engine braking operation of the vehicle by adjusting the torque of the engine according to the torque demand instead of the engine torque demand when the torque demand is greater than the engine torque demand.

6. The system of claim 5, wherein the user input is a throttle lever.

7. The system of claim 1, wherein the electronic processor is further configured to adjust the base engine braking level according to a lean angle of the vehicle.

8. The system of claim 1, wherein the electronic processor is further configured to determine the engine torque demand based on a vehicle driving resistance model.

9. The system of claim 1, wherein the electronic processor is further configured to generate the target deceleration profile based on either or both of a road gradient and a road condition.

10. The system of claim 9, wherein the electronic processor is further configured to generate the target deceleration profile based on a load of the vehicle.

11. An electronic control unit for controlling engine braking of a vehicle, the unit comprising:
an electronic processor configured to:
receive a deceleration request;
determine a base engine braking level based on a vehicle speed and a vehicle gear;
adjust the base engine braking level according to a brake pressure of the vehicle;
generate, based on the adjusted base engine braking level and the deceleration request, a target deceleration profile;
determine, based on the target deceleration profile, an engine torque demand; and
control an engine braking operation of the vehicle by adjusting a torque of an engine of the vehicle according to the engine torque demand,
wherein the engine torque demand is updated during the engine braking operation.

12. The electronic control unit of claim 11, wherein the deceleration request is received from a driver assistance system.

13. The electronic control unit of claim 1, wherein the electronic processor is further configured to generate the target deceleration profile based on a projected gear shift point.

14. The electronic control unit of claim 11, wherein the electronic processor is further configured to
receive, during the engine braking operation, a torque demand from a driver of the vehicle via a user input; and
control the engine braking operation of the vehicle by adjusting the torque of the engine according to the torque demand instead of the engine torque demand when the torque demand is greater than the engine torque demand.

15. The electronic control unit of claim 14, wherein the user input is a throttle lever.

16. The electronic control unit of claim 11, wherein the electronic processor is further configured to adjust the base engine braking level according to a lean angle of the vehicle.

17. The electronic control unit of claim 11, wherein the electronic processor is further configured to determine the engine torque demand based on a vehicle driving resistance model.

18. The electronic control unit of claim 11, wherein the electronic processor is further configured to generate the target deceleration profile based on either or both of a road gradient and a road condition.

19. The electronic control unit of claim 18, wherein the electronic processor is further configured to generate the target deceleration profile based on a load of the vehicle.

20. A method of controlling an engine braking operation of a vehicle, the method comprising:
receiving a deceleration request;
determining a base engine braking level based on a vehicle speed and a vehicle gear;
adjusting the base engine braking level according to a brake pressure of the vehicle;
generating, based on the adjusted base engine braking level and the deceleration request, a target deceleration profile;
determining, based on the target deceleration profile, an engine torque demand; and
controlling the engine braking operation of the vehicle by adjusting a torque of an engine of the vehicle according to the engine torque demand,
wherein the engine torque demand is updated during the engine braking operation.
